(19) United States
(12) Patent Application Publication
(10) Pub. No.: US 2025/0011673 A1
(43) Pub. Date: Jan. 9, 2025

(54) CARBON NANOPARTICLE COMPOSITION MATERIAL AND BEARING COATED THEREWITH

(71) Applicant: AKTIEBOLAGET SKF, GOTEBORG (SE)

(72) Inventors: Yanqin GAO, Shanghai (CN); Zhonghua ZOU, Shanghai (CN); Hongyan WANG, Shanghai (CN); Xiaobo ZHOU, Houten (NL); Shoufu LI, Shanghai (CN)

(21) Appl. No.: 18/754,361

(22) Filed: Jun. 26, 2024

(30) Foreign Application Priority Data
Jul. 4, 2023 (CN) 202310809224.6

(51) Int. Cl. C10M 169/04; C10M 107/32; C10M 125/02; C10M 125/28; C10N 40/02; C10N 50/08

(52) U.S. Cl. CPC C10M 169/04; C10M 107/32; C10M 125/02; C10M 125/28; C10M 2201/041; C10M 2201/12; C10M 2209/1033; C10N 2040/02; C10N 2050/08

(57) ABSTRACT

A composite material has polyester ether ketone matrix and additionally contains 10-50 wt. % glass fibers, and one or both of 0.1-2.0 wt. % graphene and 0.1-2.0 wt. % carbon nanotubes. An electrically insulated bearing ring has an electrically insulation layer composed of the composite material disposed on at least one surface to block leakage currents, thereby inhibiting the galvanic corrosion damage of the bearing.

### CROSS-REFERENCE

This application claims priority to Chinese patent application no. 202310809224.6 filed on Jul. 4, 2023, the contents of which are fully incorporated herein by reference.

### TECHNICAL FIELD

The present invention generally relates to a carbon nanoparticle composite material containing polyester ether ketone (PEEK) as the base (matrix) material, and to a bearing coated with the carbon nanoparticle material.

### BACKGROUND ART

In the design, manufacture and/or installation of an electric motor, deviations in pole distribution or shaft position can lead to asymmetries of the magnetic field. An alternating motion of the magnetic flux between symmetrical and asymmetrical positions can cause the motor shaft to cut the magnetic field lines during the rotation, thereby generating an induced electric potential. This induced electric potential acts between the shaft and the housing to generate a “shaft voltage”, which is applied to the inner and outer rings of the bearing. When the amplitude of the shaft voltage is big enough to break through (penetrate) the lubricant film, a current will pass through the outer ring, the lubricant film and the inner ring of the bearing, thereby generating a “shaft current” (also known as “leakage current”). The leakage current caused by the lubricant film discharge can cause micro-pits to form on the surfaces of the bearing raceways, a phenomenon known as “galvanic corrosion”. Even if the current strength is relatively weak, the galvanic corrosion phenomenon still exists.

A traditional method of blocking such a leakage current is to provide an electrical insulation coating on one or more radial surfaces of a bearing (typically on an outer surface of the outer ring and/or an inner surface of the inner ring). Conventional electrical insulation coatings are mainly made of ceramic materials, usually containing aluminum trioxide in the composition, and are formed on the above-mentioned surfaces of the bearing rings by plasma spraying. Although ceramics are insulating materials, their dielectric constants are usually between 8.5-10 and therefore they are polar or even strongly polar dielectric materials. If the inner and outer rings of a bearing are considered to be a kind of parallel plate capacitor, then according to the equation C=εS/d (where C is the capacitance value of the parallel plate capacitor, ε is the dielectric constant of the medium between the poles, S is the area of the poles, and d is the distance between the poles), a ceramic material having a relatively high dielectric constant will result in a high capacitance value of the bearing. This means that, especially under conditions in which a high-frequency shaft voltage is acting, the leakage current can still reach a high amplitude, such that the galvanic corrosion effect on the bearing has to be taken into account. In addition, the plasma spraying process inevitably leaves material pores in the ceramic coating, which requires an additional sealing process to seal such pores and to avoid the possibility that such pores will affect the electrical insulation properties of the coating owing to moisture retention in high humidity environments. Such a pore sealing process further increases the manufacturing cost of the ceramic coatings.

In order to solve the above problems, recently attempts have been made to use polymers as the constituent materials of the insulating coatings, in particular polymers having a relative dielectric constant between 3.0 and 3.5. Because the average dielectric constant of these polymers is about one-third of ceramics, the capacitance value is correspondingly one-third of the latter. Since the capacitive impedance is inversely proportional to the capacitance value, a polymer coating can make the capacitive impedance of an insulated bearing on average three times as compared to a ceramic coating. Without considering other factors, the multiplied capacitive impedance can greatly weaken the leakage current of the bearing, thereby significantly inhibiting the galvanic corrosion damage of the bearing.

However, significant inadequacies of such known polymers is their poor mechanical strength and thermal conductivity compared to metallic materials. The aforementioned inadequacies greatly limit the application of such known polymers in the field of machinery, especially in the bearing field. Therefore, there is a need for a polymer composite that can effectively block the leakage current while providing improved mechanical properties.

### SUMMARY

Thus, in one aspect of the present teachings, a composite material preferably comprises a majority (or matrix) of polyester ether ketone (PEEK), 30±20 wt. % (i.e. 10-50 wt. %) glass fiber, and one or both carbon nanoparticles selected from the group consisting of 0.1-2.0 wt. % graphene and 0.1-2.0 wt. % carbon nanotubes (CNT).

Glass fibers improve the overall mechanical strength of the composite material, graphene improves impact resistance (toughness) and thermal conductivity of the composite material, and CNT improves the overall strength and rigidity of the composite material. Composite materials having the above-noted composition exhibit both excellent insulation properties and improved mechanical properties. Such composite materials been proved to significantly curb the leakage current, thereby providing an effective solution to the problem of galvanic corrosion of bearings.

In another aspect of the present teachings, an electrically insulated bearing ring is at least partially coated with such a composite material. The electrical insulation layer formed by the composite material not only exhibits a dielectric constant comparable to polymer, but also exhibits significantly improved mechanical properties and heat dissipation performance, thereby meeting the dual requirements of rolling bearings in terms of electrical insulation and mechanical properties.

Various embodiments and advantageous technical effects of the present teachings will be described in detail below with reference to the accompanying drawings.

### BRIEF DESCRIPTION OF THE DRAWINGS

FIG. 1 shows a measured distribution of the dielectric constants of composite materials based on PEEK in embodiments of the present teachings.

FIG. 2 shows a schematic diagram of a local structure of an electrically insulated rolling bearing that has been coated with electrical insulation layer according to the present teachings.

### DETAILED DESCRIPTION

In the following description, the same or similar reference numerals are used throughout to indicate the same or similar elements. In addition, terms indicating orientations, such as “axial”, “radial” and “circumferential”, refer to the axial, radial and circumferential directions of the element being described unless otherwise limited or specified.

Polyester ether ketone (PEEK) is a polymer that exhibits both rigidity and flexibility, and excels in fatigue resistance under alternating stress. It has good electrical insulation properties even at very high temperatures, and the dielectric loss is very small at high frequencies. These properties make it particularly suitable for use as an insulation layer material for electrically insulated bearings. In the present teachings, the content of PEEK in the composite material is preferably at least 48 wt. % of the total weight of the composite material, preferably between 50-90 wt. %, e.g., between 60-90 wt. %, e.g., between 70-90 wt. %, according to the needs of the particular application.

When added to PEEK as the base (matrix) material, glass fibers (abbreviated as GF) further improve its mechanical strength. Glass fibers are an inorganic non-metallic material exhibiting excellent performance, characterized by high specific strength that can be several times the specific strength of low carbon steel. In the present teachings, the content of glass fiber can be between 10-50 wt. %, preferably between 10-30 wt. %, more preferably between 10-20 wt. %, according to the needs of the particular application (for example, as required to increase mechanical strength).

In addition, the physical and chemical properties of the composite material can be further improved by adding graphene and/or carbon nanotubes (CNT for short) to the PEEK matrix. Herein, graphene nanoplatelets (GNP for short), which are also known as graphene nanosheets (GNS for short), or carbon nanoflakes (CNF for short), which is a two-dimensional graphite nanomaterial having a thickness of nanometer size, are used as the graphene component of the composite material. In some exemplary embodiments of the present teachings, a single layer of graphene can be used. The carbon nanotubes used in the present teachings may be single-walled nanotubes, double-walled nanotubes and/or multi-walled nanotubes.

The composite material optionally may contain one or more additional additives depending on the particular application of the present teachings, including but not limited to colorants (pigments), ultraviolet protectors, antioxidants, thermal stabilizers, flame retardants, plasticizers, formability additives, etc.

The composite material may be directly applied to the material to be electrically insulated, e.g., a bearing ring, in a variety of ways, including but not limited to spraying, dip coating, insert molding, injection molding, 3-D printing, etc. In addition or in the alternative, an electrical insulator may be formed separately, e.g., by injection molding, 3-D printing, etc. and then attached to the material to be electrically insulated, e.g., using an adhesive or by fusing or form- or interference-fitting.

The inner and/or outer rings of the bearing are preferably composed of a steel composition. The present teachings are widely applicable to a variety of steel compositions, such as 100Cr6 (SAE 52100), St4 (DDS), 100CrMnSi6-4 (SAE 52100 Grade2), case hardening steels (SAE 5280, SAE 4320), Cronidur 30, M50, M50NiL, etc.

In roller bearing applications, the rolling elements (roller bodies) may be composed of the same or different steel composition, such as any of the steel compositions listed above, or may be ceramic rolling elements, such as silicon nitride. A cage optionally may be used to contain and guide the rolling elements.

The shape of the bearing rings and the rolling elements is not particularly limited. Representative, non-limiting examples of bearing types that may be utilized with the present teachings are ball bearings, cylindrical rollers, spherical rollers, gear bearings, tapered rollers, needle rollers, CARB toroidal roller bearings, angular contact bearings, self-aligning bearings, thrust bearings, etc. The bearings may have a single row of rolling elements or multiple rows of rolling elements side-by-side.

Remarkable material properties of the present composite materials demonstrated with experiment results are described in detail below according to three specific embodiments.

Embodiment 1: Composite material containing PEEK as the base material and 15 wt. % GF

Embodiment 2: Composite material containing PEEK as the base material and 15 wt. % GF and 0.2 wt. % GNP

Embodiment 3: Composite material containing PEEK as the base material and 15 wt. % GF and 0.4 wt. % GNP

Embodiment 4: Composite material containing PEEK as the base material and 15 wt. % GF and 0.2 wt. % CNT

TABLE 1

| | | | | | | | Charpy |
|---|---|---|---|---|---|---|---|
| | | | Tensile | | | Flexural | Unnotched |
| | Tensile | Tensile | Elongation | Flexural | Flexural | Elongation | Impact |
| Embodiments | Strength | Modulus | at Break | Strength | Modulus | at Break | Strength |
| 1~4 | (MPa) | (Mpa) | (%) | (MPa) | (MPPa) | (%) | (kJ/m²) |
| #1 PEEK | 130 | 7466 | 2.45 | 191 | 5916 | 3.77 | 36 |
| 15GF | | | | | | | |
| #2 PEEK | 121.5 | 7122 | 2.48 | 198 | 5688 | 4.13 | 48.27 |
| 15GF 0.2GNP | | | | | | | |
| #3 PEEK | 126 | 7375 | 2.66 | 201 | 5879 | 4.03 | 42.8 |
| 15GF 0.4GNP | | | | | | | |
| #4 PEEK | 133 | 7710 | 2.48 | 224 | 6949 | 4.15 | 34.6 |
| 15GF 0.2CNT | | | | | | | |

Table 1 shows the measured values of mechanical properties of composite materials based on PEEK in different embodiments. It can be seen from Table 1 that the addition of CNT, even in a small amount (0.2 wt. %), can comprehensively improve the mechanical properties of the composite material, especially the ability to resist deformation (i.e. rigidity), including tensile strength, tensile modulus, flexural strength, flexural modulus, and flexural elongation at break.

Among these properties, the increase of flexural modulus in Embodiment 4 is the most significant. That is, as compared with Embodiment 1 that contains only PEEK and GF, the strength of the composite material of Embodiment 4 increased from 5916 MPa (megapascal) to 6949 MPa by adding CNT, which is an increase of 17%. The content of CNT can be further adjusted according to the needs of the particular application, and the preferred range of CNT can be between 0.1-2.0 wt. %, e.g., between 0.1-1.0 wt. %, e.g. between 0.1-0.5 wt. %, e.g., between 0.1-0.3 wt. %.

In addition, it can also be seen from Table 1 that, although the addition of GNP in Embodiments 2 and 3 did not improve the deformation resistance of the material, it significantly improved the impact resistance (i.e. toughness) of the material. For different applications of the present teachings, the content of GNP can be varied appropriate. For example, the content of GNP can be between 0.1-2.0 wt. %, e.g., between 0.1-1.0 wt. %, e.g., between 0.1-0.5 wt. %, e.g., between 0.3-0.5 wt. %. However, comparing Embodiment 2 and Embodiment 3, it can be seen that the effect of 0.2 wt. % GNP on improving the Charpy impact strength is more than that of 0.4 wt. % GNP, suggesting that the content of GNP near 0.2 wt. % may reach a peak of material toughness (the possibility of a regional peak is not excluded).

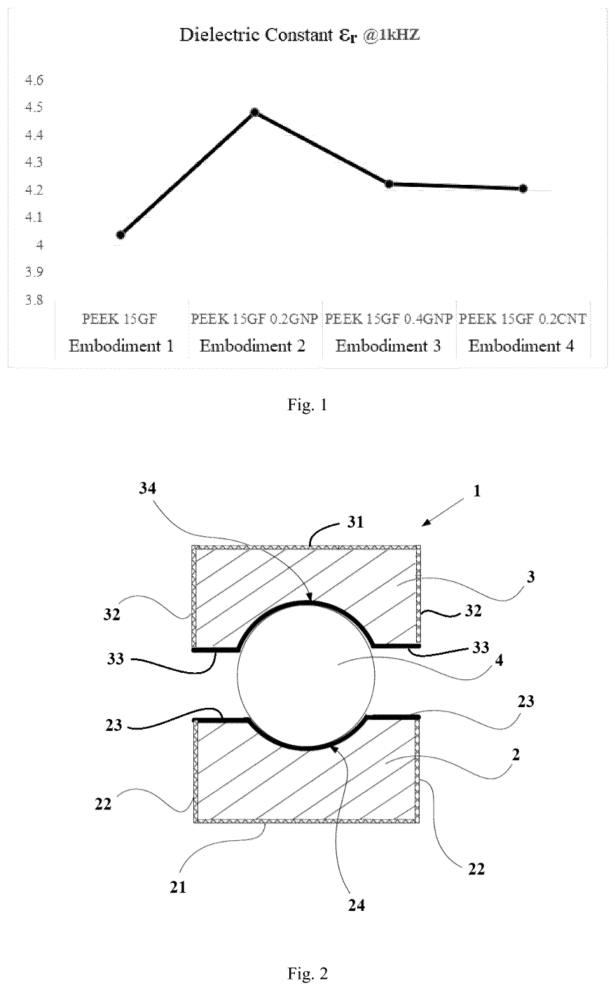

FIG. 1 shows a measured distribution of the dielectric constants of the composite materials containing PEEK as the base material in different embodiments. Although Table 1 shows that 0.2 wt. % GNP can make the impact strength (toughness) of the material reach a peak, FIG. 1 shows that this content of GNP can increase the dielectric constant εr of the material to nearly 4.5. This result leads to an increase in the capacitance value of the bearing having such a composite material as the electrical insulation layer, which is unfavorable for eliminating the galvanic corrosion effect of the bearing. In contrast, neither 0.4 wt. % GNP nor 0.2 wt. % CNT had a significant effect on improving the dielectric constant of the material, which to a certain extent eliminates concerns that carbon nanomaterials could greatly increase the conductivity of the composite material.

TABLE 2

| | | Embodi- | Embodi- | Embodi- |
|---|---|---|---|---|
| Thermal | Embodi- | ment 2 | ment 3 | ment 4 |
| Conductivity | ment 1 | PEEK 15GF | PEEK 15GF | PEEK 15GF |
| (W/(m · K)) | PEEK 15GF | 0.2GNP | 0.4GNP | 0.2CNT |
| 25° C. | 0.3 | 0.3 | 0.4 | 0.3 |
| 50° C. | 0.3 | 0.3 | 0.4 | 0.3 |
| 80° C. | 0.3 | 0.3 | 0.4 | 0.3 |
| 100° C. | 0.3 | 0.3 | 0.4 | 0.3 |
| 120° C. | 0.3 | 0.3 | 0.4 | 0.3 |

Table 2 shows the measured values of thermal conductivity of the composite materials of different embodiments at different temperatures. It can be seen from Table 2 that the 0.4 wt. % GNP in Embodiment 3 can increase the thermal conductivity of the material by over 30% compared to the other embodiments. This is very beneficial for bearing applications, since good heat dissipation is a prerequisite for reliable bearing operation.

Various embodiments of composite materials having improved properties obtained by different types and amounts of carbon nanomaterial additions to PEEK are described above. It can be seen that the material in Embodiment 3 (PEEK 15GF 0.4GNP) has comprehensive advantages in terms of impact resistance (toughness), dielectric constant and heat dissipation, and the material in Embodiment 4 (PEEK 15GF 0.2CNT) has comprehensive advantages in terms of deformation resistance (rigidity) and dielectric constant.

It is necessary to point out that up to now, there is neither experiment nor literature disclosing any contradiction between graphene and carbon nanotubes in material modification. On the contrary, theory has proved that the stable structure of carbon nanotubes can provide good support for graphene, and the softness of graphene can provide advantages for filling the voids of carbon nanotubes. Moreover, the synergistic effect between graphene and carbon nanotubes can improve the thermal conductivity of the material, so that the spatial structure and physical and chemical properties of the two can complement each other. In view of this, in combination with Embodiment 3 and Embodiment 4, on the basis of an applicable proportion (including but not limited to 15 wt. %) of GF addition to PEEK, by adding both 0.4 wt. % GNP and 0.2 wt. % CNT, the resulting material can gain advantageous performance in many aspects such as deformation resistance, toughness, dielectric constant and heat dissipation at the same time, thereby realizing the best solution for a particular application of the present teachings in a comprehensive sense. A presently preferred embodiment can be summarized as comprising 15±5 wt. % glass fibers, 0.4±0.1 wt. % graphene and 0.2±0.1 wt. % carbon nanotubes.

FIG. 2 shows a schematic diagram of a local structure of a rolling-element bearing that has the above-mentioned composite material as an electrical insulation layer. Taking a ball bearing as a representative example, the rolling bearing 1 includes an inner ring 2, an outer ring 3 and at least one row of rolling bodies (rolling elements) 4 disposed between an inner ring raceway 24 and an outer ring raceway 34. Unlike non-insulated bearings, the insulated bearing 1 shown in FIG. 2 has an insulation coating formed (disposed) on one or more surfaces of the inner ring 2 and/or outer ring 3 for blocking (inhibiting) the passage of electric current. In the specific embodiment shown in FIG. 2, said insulation coating may be formed on an inner surface 21 of the inner ring 2 and/or an outer surface 31 of the outer ring 3. In addition or in the alternative, the insulation coating may be formed on the end surfaces 22 on one or both axial sides of the inner ring 2 and/or on the end surfaces 32 on one or both axial sides of the outer ring 3 of the bearing 1. In principle, the insulation coating can be formed on all surfaces of the inner ring 2 and outer ring 3 of the bearing except the raceways 24 and 34, even including the respective surfaces of the shoulders 23 on both sides of the inner ring raceway 24 and the shoulders 33 on both sides of the outer ring raceway 34. In the following description, all the above-mentioned surfaces of the bearing ring that can be coated with the insulation coating to prevent the leakage current through the rolling bearing are referred to as “corresponding surface(s)”.

In summary, by adding glass fibers and carbon nanomaterials, the present invention successfully realizes the “directional” modification of PEEK. On the basis of PEEK's lower dielectric constant (relative to ceramics), the addition of glass fibers and carbon nanomaterials has produced a comprehensive improvement in the mechanical properties of the material. The electrical insulation layer formed by this material can greatly reduce the leakage current of the bearing and significantly inhibit the galvanic corrosion damage of the bearing. In addition, such material can also be formed on the corresponding surface of a bearing ring by injection molding or spraying, the thickness of which can reach as low as 10 microns. The light and thin insulating layer has little effect on the size of a bearing, with which such insulated bearing can be used to replace the existing non-insulated bearings perfectly.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved composite materials, and applications of such composite materials, such as electrically insulated bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

We claim:

1. A composite material comprising a mixture of:
at least 48 wt. % polyester ether ketone,
10-50 wt. % of glass fibers, and
one or both carbon nanoparticles selected from the group consisting of 0.1-2.0 wt. % of graphene and 0.1-2.0 wt. % of carbon nanotubes.

2. The composite material according to claim 1, wherein the composite material contains:
10-30 wt. % of glass fibers, and
one or both carbon nanoparticles selected from the group consisting of 0.1-1.0 wt. % of graphene and 0.1-1.0 wt. % of carbon nanotubes.

3. The composite material according to claim 1, wherein the composite material contains:
10-20 wt. % of glass fibers, and
one or both carbon nanoparticles selected from the group consisting of 0.1-0.5 wt. % of graphene and 0.1-0.5 wt. % of carbon nanotubes.

4. The composite material according to claim 3, wherein the composite material contains 0.3-0.5 wt. % graphene.

5. The composite material according to claim 3, wherein the composite material contains 0.1-0.3 wt. % carbon nanotubes.

6. The composite material according to claim 5, wherein the composite material contains 0.3-0.5 wt. % graphene.

7. A bearing ring having an electrical insulation layer on a surface of the bearing ring, the electrical insulation layer being composed of a composite material comprising a mixture of:
at least 48 wt. % polyester ether ketone,
10-50 wt. % of glass fibers, and
one or both carbon nanoparticles selected from the group consisting of 0.1-2.0 wt. % of graphene and 0.1-2.0 wt. % of carbon nanotubes.

8. The bearing ring according to claim 7, wherein the composite material contains:
10-30 wt. % of glass fibers, and
one or both carbon nanoparticles selected from the group consisting of 0.1-1.0 wt. % of graphene and 0.1-1.0 wt. % of carbon nanotubes.

9. The bearing ring according to claim 7, wherein the composite material contains:
10-20 wt. % of glass fibers, and
one or both carbon nanoparticles selected from the group consisting of 0.1-0.5 wt. % of graphene and 0.1-0.5 wt. % of carbon nanotubes.

10. The bearing ring according to claim 9, wherein the composite material contains 0.3-0.5 wt. % graphene.

11. The bearing ring according to claim 9, wherein the composite material contains 0.1-0.3 wt. % carbon nanotubes.

12. The bearing ring according to claim 11, wherein the composite material further contains 0.3-0.5 wt. % graphene.

13. A rolling-element bearing comprising:
the bearing ring according to claim 12; and
a plurality of rolling elements in contact with a raceway surface of the bearing ring, wherein the composite material is not disposed on the raceway surface.

14. A rolling-element bearing comprising:
two of the bearing rings according to claim 12; and
a plurality of rolling elements in contact with raceway surfaces of the two bearing rings, wherein the composite material is not disposed on the raceway surfaces.

15. The rolling-element bearing according to claim 14, wherein the bearing rings are composed of steel.

16. A rolling-element bearing comprising:
the bearing ring according to claim 1; and
a plurality of rolling elements in contact with a raceway surface of the bearing ring, wherein the composite material is not disposed on the raceway surface.

17. A rolling-element bearing comprising:
two of the bearing rings according to claim 16; and
a plurality of rolling elements in contact with raceway surfaces of the two bearing rings, wherein the composite material is not disposed on the raceway surfaces.

18. The rolling-element bearing according to claim 17, wherein the bearing rings are composed of steel.
